(19) United States
(12) Patent Application Publication
(10) Pub. No.: US 2008/0009325 A1
(43) Pub. Date: Jan. 10, 2008

(54) MENU INTERFACE FOR MOBILE COMMUNICATIONS DEVICE

(75) Inventors: RONALD SCOTTE ZINN, Waterloo (CA); ANDREW D. BOCKING, Waterloo (CA); SHERRYL LEE LORRAINE SCOTT, Toronto (CA)

Correspondence Address: RIDOUT & MAYBEE;SUITE 2400, ONE QUEEN STREET EAST, TORONTO, ON, M5C3B1, US

(73) Assignee: RESEARCH IN MOTION LIMITED, Waterloo (CA)

(21) Appl. No.: 11/456,286

(22) Filed: Jul. 10, 2006

(51) Int. Cl. H04M 1/00; H04B 1/38

(52) U.S. Cl. 455/566; 455/556.2

(57) ABSTRACT

A hand-held electronic mobile device that includes a controller including at least one processor, for controlling operation of the mobile device, a display coupled to the controller, a user input device coupled to the controller for receiving user input selections, a storage coupled to the controller; and a rigid case dimensioned to be held in a hand of a user, the case housing the controller, the display, the user input device and the storage. The controller is operative to (i) generate on the display a user interface screen having a plurality of user selectable icons, one of the icons being an options icon; (ii) generate on the display, in response to user selection of the options icon, a main options menu listing a plurality of user selectable option items, at least one of the option items being an expandable menu item associated with a group of user selectable sub-menu option items; (iii) generate on the display, in response to user selection of the at least one expandable menu item, a sub-menu listing the sub-menu option items; (iv) generate on the display, in response to user selection of at least one of the sub-menu option items, a user interface screen for a user to change an operational setting of the mobile device.

### FIELD

Example embodiments described herein relate to mobile communications devices and, in particular, to user interface menus for such devices.

### BACKGROUND

Communications devices, in particular handheld mobile communications devices, are becoming increasingly sophisticated. There are increasing options and functions available to a user of such a device.

Typically, a communications device has an options menu for the user to adjust the settings on the device. The option menu may have a number of option items for the user to select.

In some devices, options are listed alphabetically in a list. If a user wishes to select an option, the user may scroll or toggle down the options menu to select the desired option. The scrolling may waste valuable time, as is the case when the option starts with a high letter of the alphabet. In addition, a user may wish to continually select the same option or options in a give timeframe and would have to scroll or toggle down the option menu each time.

### BRIEF DESCRIPTION OF THE DRAWINGS

Example embodiments will now be described by way of example with reference to the accompanying drawings, through which like reference numerals are used to indicate similar features.

FIG. 1 shows a block diagram of an example of a mobile communications device to which example embodiments of an options module can be applied;

FIG. 2 shows a further operational block diagram representation of the mobile communications device of FIG. 1;

FIG. 3 shows, in diagrammatic form, a front view of an example of the device of FIG. 1

FIGS. 4A and 4B show a diagrammatic view of an options menu on a graphical user interface screen in a first example embodiment;

FIG. 5 shows a diagrammatic view of a sample interface reached from the options menu of FIGS. 4A and 4Bh the first example embodiment

FIGS. 6A and 6B shows a diagrammatic view of an advanced options menu in accordance with the first example embodiment;

FIG. 7 shows a diagrammatic view of an option configuration interface screen for a Browser option in accordance with an example embodiment;

FIG. 8 shows a diagrammatic view of an application interface screen for an application option in accordance with an example embodiment;

FIG. 9 shows a diagrammatic view of a security options menu in accordance with an example embodiment;

FIG. 10 shows a diagrammatic view of a general settings interface screen in accordance with an example embodiment;

FIG. 11 shows a diagrammatic view of an options menu on a graphical user interface screen in a further example embodiment;

FIG. 12 shows a diagrammatic view of another prioritized options menu in accordance with a further example embodiment;

FIG. 13 shows a illustrative view of another options menu in accordance with still a further example embodiment; and

FIG. 14 shows an expanded view of the menu of FIG. 13.

### DETAILED DESCRIPTION

According to one example embodiment is a hand-held electronic mobile device that includes a controller including at least one processor, for controlling operation of the mobile device, a display coupled to the controller, a user input device coupled to the controller for receiving user input selections, a storage coupled to the controller; and a rigid case dimensioned to be held in a hand of a user, the case housing the controller, the display, the user input device and the storage. The controller is operative to (i) generate on the display a user interface screen having a plurality of user selectable icons, one of the icons being an options icon; (ii) generate on the display, in response to user selection of the options icon, a main options menu listing a plurality of user selectable option items, at least one of the option items being an expandable menu item associated with a group of user selectable sub-menu option items; (iii) generate on the display, in response to user selection of the at least one expandable menu item, a sub-menu listing the sub-menu option items; (iv) generate on the display, in response to user selection of at least one of the sub-menu option items, a user interface screen for a user to change an operational setting of the mobile device.

According to another example embodiment is a method of generating options menus on a hand-held electronic mobile device that includes a hand-held case with a display and a user input device, the method including: generating on the display a user interface screen having a plurality of user selectable icons, one of the icons being an options icon associated with user configurable options for the mobile device; generating on the display, in response to user selection of the options icon, a main options menu listing a plurality of user selectable option items, at least one of the option items being an expandable menu item associated with a group of sub-menu option items; generating on the display, in response to user selection of the at least one expandable menu item, a sub-menu listing the sub-menu option items; and generating on the display, in response to user selection of at least one of the sub-menu option items, a user interface screen for a user to change an operational setting of the mobile device.

According to another example embodiment is a hand-held electronic mobile device comprising a controller including at least one processor, for controlling operation of the mobile device; a display coupled to the controller; a user input device coupled to the controller for receiving user input selections; a storage coupled to the controller; and a rigid case dimensioned to be held in a hand of a user, the case housing the controller, the display, the user input device and the storage. The controller is operative to (i) generate on the display a user interface screen having a plurality of user selectable icons including at least one icon for linking to a list of menu items; (ii) generate on the display, in response to user selection of the at least one icon, a main menu listing a plurality of user selectable menu option items, at least one of the menu option items being an expandable menu item associated with a group of user selectable sub-menu option items; and (iii) generate on the display, in response to user selection of the at least one expandable menu item, a sub-menu listing the sub-menu option items; the controller adaptively allocating the option items between the main menu and the sub-menu in dependence on a user selection history for the option items.

According to another example embodiment is a method of generating options menus on a hand-held electronic mobile device, comprising: providing a hand-held case with a display and a user input device, the device being configured for generating on the display a main menu listing a plurality of user selectable menu items and an expandable menu item associated with a group of sub-menu items; generating on the display, in response to user selection of the expandable menu item, a sub-menu listing a plurality of menu items; and adaptively allocating the menu items between the main menu and the sub-menu in dependence on a user selection history for the menu items.

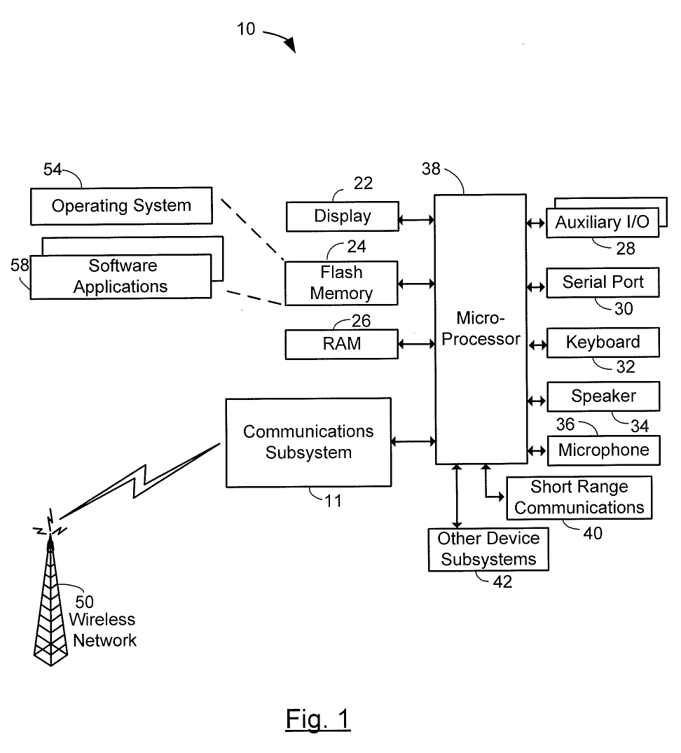

Referring now to the drawings, FIG. 1 is a block diagram showing an example of an electronic hand held mobile communications device 10 to which example embodiments of the options module described herein can be applied. The communications device 10 is a two-way mobile communication device having voice and messaging communications capabilities. Depending on the functionality provided by the device 10, in various embodiments the device 10 may be a data communication device, a multiple-mode communication device configured for both data and voice communication, a mobile telephone, a PDA enabled for wireless communication, a pocket computer system with a wireless modem or wireless network card, or a computer or phone device with a fixed connection to a network, among other things. The device 10 is in at least some example embodiments a handheld device dimensioned to fit, for example, in a belt-mounted holster, a pocket or a purse.

In the example embodiment shown in FIG. 1, the device 10 includes a communication subsystem 11. The communication subsystem 11 may include one or more receivers, transmitters, and associated components such as one or more antenna elements, and a processing module such as a digital signal processor (DSP). As will be apparent to those skilled in the field of communications, the particular design of the communication subsystem 11 will be dependent upon the communication network(s) in which the device 10 is intended to operate.

Signals received by the device 10 from a wireless communication network 50 are input to the receiver of the communication subsystem 11, which may perform such common receiver functions as signal amplification, frequency down conversion, filtering, channel selection and the like. In a similar manner, signals to be transmitted are processed, including modulation and encoding for example, by the DSP and input to the transmitter for digital to analog conversion, frequency up conversion, filtering, amplification and transmission over the wireless communication network 50.

The device 10 includes a controller implemented using at least one microprocessor 38 that controls the overall operation of the device. The microprocessor 38 interacts with the communications subsystem 11 and also interacts with further device subsystems such as a display 22, flash memory 24, random access memory (RAM) 26, one or more auxiliary input/output (I/O) subsystems or devices 28 (e.g. a thumbwheel 28a), serial port 30, keyboard or keypad 32, speaker 34, microphone 36, a short-range communications subsystem 40, and any other device subsystems generally designated as 42.

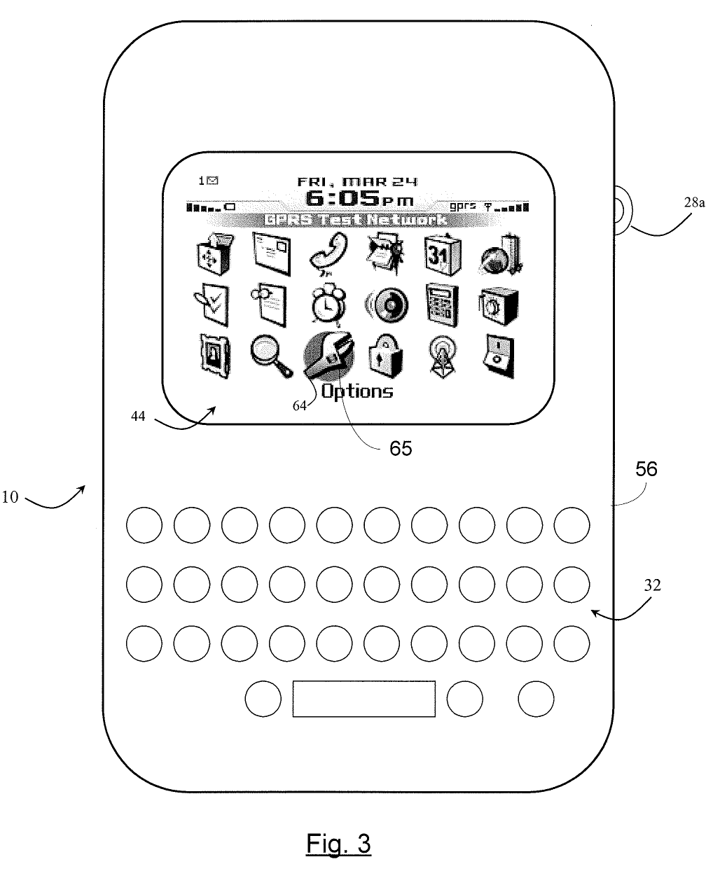

FIG. 3 shows, in diagrammatic form, a front view of an example handheld embodiment of the device 10 of FIG. 1. The components of the device are housed in a casing 56, which is dimensioned to be held in the hand of a user. As illustrated, the casing 56 does not include any moving parts, however in alternative embodiments the casing 56 and can include multiple casing elements (for example two casing elements) that are rotatably, pivotally or slidably connected together, with for example the screen being located in casing element that is movable relative to a second casing element in which a keypad is housed. The device 10 includes a display screen 44 of the display 22, alphanumeric keyboard or keypad 32 and thumbwheel 28a, which can be rotated in opposite directions to move an on-screen position marker and depressed to select an option of function highlighted by the on-screen position marker.

Referring again to FIG. 1, operating system software 54 and various software applications 58 used by the microprocessor 38 are, in one example embodiment, stored in a persistent store such as flash memory 24 or similar storage element. Those skilled in the art will appreciate that the operating system 54, software applications 58, or parts thereof, may be temporarily loaded into a volatile store such as RAM 26. It is contemplated that received communication signals may also be stored to RAM 26.

The microprocessor 38, in addition to its operating system functions, in example embodiments enables execution of software applications 58 on the device. A predetermined set of software applications 58 which control basic device operations, including data and voice communication applications for example, will normally be installed on the device 10 during manufacture. Further software applications 58 may also be loaded onto the device 10 through the wireless communication network 50, an auxiliary I/O subsystem 28, serial port 30, short-range communications subsystem 40 or any other suitable subsystem 42, and installed by a user in the RAM 26 or a non-volatile store for execution by the microprocessor 38. Such flexibility in application installation increases the functionality of the device and may provide enhanced on-device functions, communication-related functions, or both. For example, secure communication applications may enable electronic commerce functions and other such financial transactions to be performed using the device 10.

In a data communication mode, a received signal such as a text message or web page download will be processed by the communication subsystem 11 and input to the microprocessor 38, which further process the received signal for output to the display 22 through the graphics subsystem 44, or alternatively to an auxiliary I/O device 28. A user of device 10 may also compose data items within a software application 58, such as email messages and calendar entries for example, using the keyboard 32 in conjunction with the display 22 and possibly an auxiliary I/O device 28 (e.g. the thumbwheel 28a). Such composed items may then be transmitted and received over a communication network through the communication subsystem 11.

The serial port 30 (which may be for example a universal serial bus (USB) port) in FIG. 1 may enable a user to set preferences through an external device or software application and would extend the capabilities of the device by providing for information or software downloads to the device 10 other than through a wireless communication network.

The short-range communications subsystem 40 is a further component which may provide for communication between the device 10 and different systems or devices, which need not necessarily be similar devices. For example, the subsystem 40 may include an infrared device and associated circuits and components or a Bluetooth™ communication module to provide for communication with similarly enabled systems and devices.

Wireless communication network 50 is, in an example embodiment, a wireless wide area packet data network, which provides radio coverage to mobile devices 10. Wireless communication network 50 may for example be a voice and data network such as GSM (Global System for Mobile Communication) and GPRS (General Packet Radio System), CDMA (Code Division Multiple Access), or various other third generation networks such as EDGE (Enhanced Data rates for GSM Evolution) or UMTS (Universal Mobile Telecommunications Systems). In some example embodiments, network 50 is a wireless local area network (WLAN), such as for example a network compliant with one or more of the IEEE 802.11 family of standards. In some example embodiments, the device 10 is configured to communicate in both data and voice modes over both wireless wide area network (WAN) and WLAN networks and to roam between such networks.

Also stored in flash memory 24 are storage modules for contact information 310 and stored settings 312. In some embodiments, such information could be stored wholly or partly on persistent memory carried on a transportable memory device such as a SIM (Subscriber Identity Module) card for example.

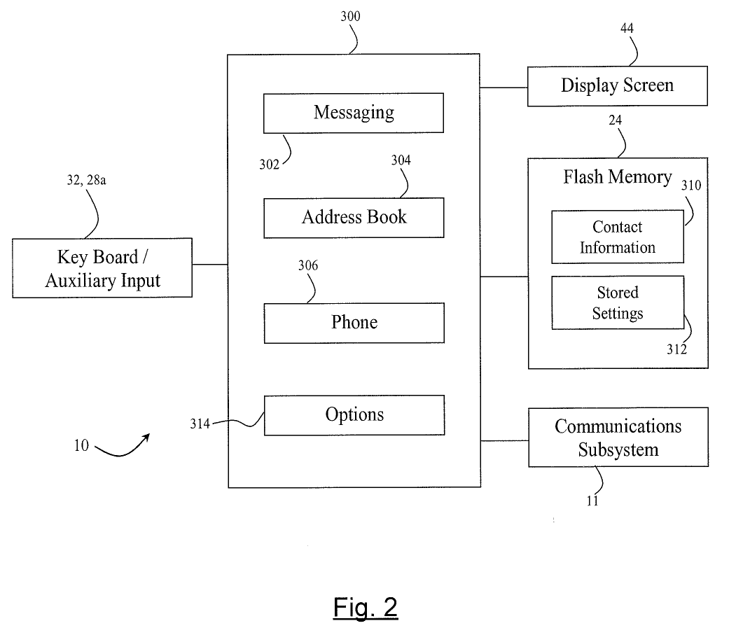

Under instructions from various software applications 58 resident on the device 10, the processor 38 is configured to implement various functional components or modules 300, some of which are represented in FIG. 2, for interacting with the device subsystems described above. In an example embodiment, the software resident on the device 10 includes applications for implementing an address book 304, a telephone 306, and electronic messaging 302, and options 314. In some embodiments, some or part of the functionality of the functional modules 300 can be implemented through firmware or hardware components instead of, or in combination with, computer software instructions executed by the microprocessor 38 (or other processors).

The options module 314 (which may be implemented as part of the device operating system, or as a stand-alone application, or as part of one or more other applications) enables the device to display a main options menu including a number of option items to the device user. Upon user selection of an option item, the options module 314 may display a sub-menu of further selectable option items that are associated with the selected item, or display information about the selected option item, and in some cases facilitate user configuration of device settings pertaining to the selected option item. The option module 314 facilitates user configuration of a number of settings on the device 10.

With reference to FIG. 3, in at least some example embodiments, the modules 300 each have an associated selectable icon that is displayed on the screen 44 as part of a graphical user interface. For example, FIG. 3 shows an icon 64 for the options module 314. As shown, the options icon 64 is highlighted or focused by an on-screen position marker or selection indicator 65 that is moved throughout screen 44 in response to rotation of scrollwheel 28a (or user manipulation of another suitable navigation input mechanism).

Depressing the scrollwheel 28a (or pressing another predetermined selection key) while the options icon 64 is focused or highlighted results in a graphical user interface being generated on screen 44 through which a user of the device can ultimately select and configure various device options. For example, option items may include, among other things: About, Applications, Auto On/Off, Autotext, Bluetooth, Browser Push, Cell Broadcast, Certificate Servers, Certificates, Custom Wordlist, Date/Time, Enterprise Activation, Firewall, Host Routing Table, Key Stores, Language, Location Based Services, Memory Cleaning, Message Services, Multimedia Messaging Service (MMS), Network, Owner, Screen/Keyboard, Security Options, Service Book, Subscriber Identity Module (SIM) Card, Secure/Multipurpose Internet Mail Extensions (S/MIME), Smart Card, Short Message Service (SMS), Status, Transport Control Protocol (TCP), Theme, Transport Layer Security (TLS), Voice Over Internet Protocol (VOIP) Virtual Private Network (VPN), Wireless Local Area Network (WLAN), and Wireless Transport Layer Security (WTLS). In some devices, such options may be arranged alphabetically in a single list. However, such a configuration can be cumbersome as the device user has to scroll through a lengthy options list, including options that are rarely used, in order to arrive at the option that the user wants to change. The embodiments described herein seek to mitigate this cumbersome configuration by using multiple levels or tiers to arrange at least some of the selectable options into user selectable groups.

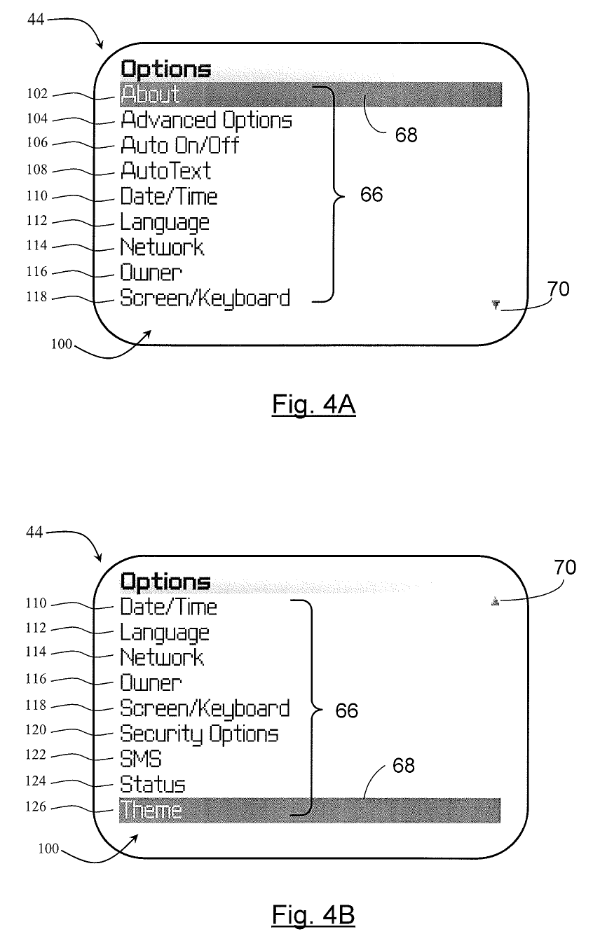

FIGS. 4A and 4B show a main options menu 100 displayed on the screen 44 in response to user selection of the options icon 64. The main options menu lists a number of user selectable items 66. By rotating the scrollwheel 28a (or using another suitable navigation input interface), a device user can move a position marker or selection indicator 68 through listed option items 66. FIG. 4A shows a first group of option items 66 on the main options menu 100. As indicated by arrow 70, more option items 66 are available in main options menu 100 than can be displayed at one time on display screen 44. Moving the selection indicator 68 will cause additional option items 66 to scroll onto the display screen 44, and FIG. 4B shows the remaining options items in the option menu 100, with the selection indicator 68 being positioned to highlight the final item “Theme” 126 in the list. The main options menu 100 has a plurality of user selectable option items, including: “About” 102, “Advanced Options 104”, Auto on/off” 106, “Autotext” 108, “Date/Time” 110, “Language” 112, “Network” 114, “Owner” 116, “Screen/Keyboard” 118, “Security Options” 120, “Short Message Service (SMS)” 122, “Status” 124, and “Theme” 126.

Some of the option items 66 link directly to user interfaces in which either information is presented on the screen 44, or the user is presented with an interface that they can use to change an operational setting of the device that is associated with an option item 66. However, some of the option items 66 are expandable menu items that link to further sub-menus that display additional selectable option items.

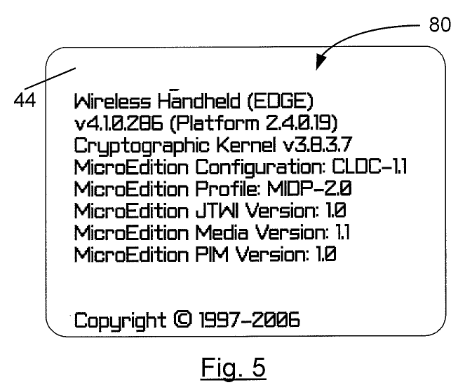

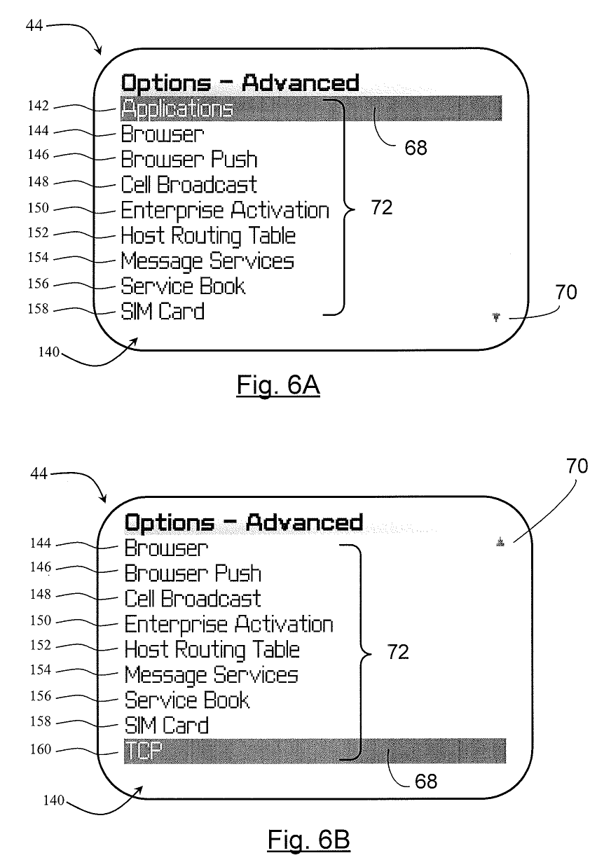

By way of example, selecting the item “About” 102 results in the interface 80 being displayed on the screen 44, as shown in FIG. 5. The interface 80 includes information about the software and hardware used to implement the mobile device 10. However, referring again to main options menu interface 100 in FIGS. 4A and 4B, selecting the option item “Advanced Options” 104 (which is an expandable menu item) does not bring the user directly to the user interface screen for a specific option, but rather causes a further “Advanced Options” sub-menu listing a further group of potions to be displayed. Thus, the expandable menu item “Advanced Option” 104 links to a sub-menu. In this regard, FIGS. 6A and 6B show a diagrammatic view of an “Advanced Options” sub-menu 140 in accordance with a first example embodiment. The sub-menu 140 lists a number of user selectable menu items 72. By rotating the scrollwheel 28a (or using another suitable navigation input interface), a device user can move a position marker or selection indicator 68 through listed option items 72. In some example embodiments, the selection indicator 68 will appear automatically at the first listed menu item (in this case item 142) when the sub-menu interface 140 is displayed. In some example embodiments, when the sub-menu interface is displayed the selection indicator 68 will automatically appear over the last menu item that was selected from the sub-menu interface 140 the last time that the sub-menu interface 140 was displayed. For example, if the last time that a user accessed the sub-menu interface 140 the user selected the menu item 156 “Service Book”, then the next time that the user opened the sub-menu interface 140 the selection indicator 68 would be positioned to highlight menu item 156 “Service Book” so that that menu item could then be selected by immediately pressing the scrollwheel 18a (or other predetermined selection key). Locating the selection indicator automatically on the last-selected menu item upon entering a menu is a feature that can be applied to each of the menu interfaces described herein.

FIG. 6A shows a first group of option items 72 on the advanced options sub-menu 140. As indicated by arrow 70, more option items 72 are available in options sub-menu 140 than can be displayed at one time on display screen 44. Moving the selection indicator 68 will cause additional option items 72 to scroll onto the display screen 44, and FIG. 6B shows the remaining options items 72 on the advanced option sub-menu 140. The Advanced Options sub-menu 140 is displayed on the screen 44 when the user selects the advanced options 104 from options menu 100. As shown in FIGS. 6A and 6B, the Advanced Options sub-menu 140 has a plurality of advanced options items 72, including: Applications 142, Browser 144, Browser Push 146, Cell Broadcast 148, Enterprise Activation 150, Host Routing Table 152, Message Services 154, Service Book 156, Subscriber Identity Module (SIM) Card 158, And Transport Control Protocol (TCP) 160.

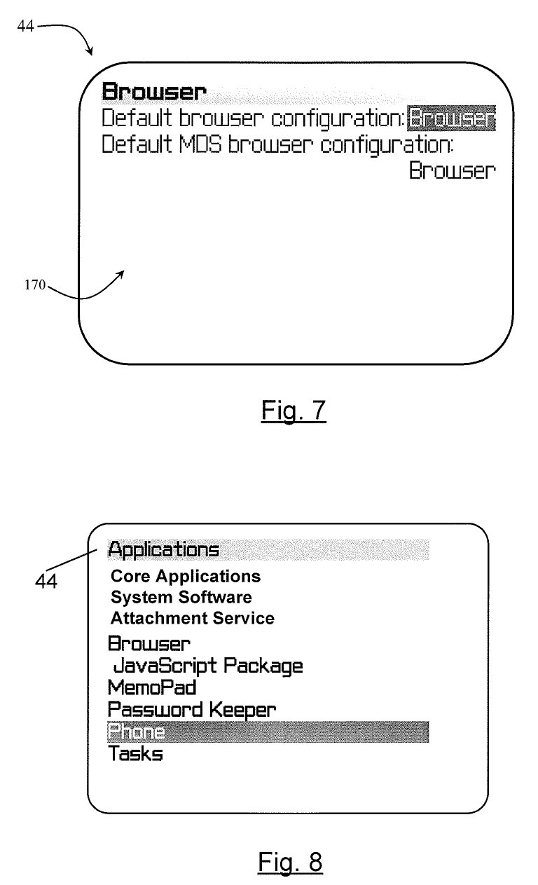

Selecting one of the option items 72 will result in a user interface being generated that either displays information about the option, and/or allows the user to configure settings for the selected option. By way of example, FIG. 7 shows a diagrammatic view of an option configuration interface screen 170 that is associated with the “Browser” option item 144 and which is displayed when “Browser” option item 144 is selected by a user from the interface screen 140. The option configuration interface screen 170 permits a user to view and change settings pertaining to the default browser configurations applied to the mobile device 10.

Referring again FIGS. 6A and 6B, selecting the option item “Applications” 142 links to a further user interface screen as shown in FIG. 8 which lists the applications that are present on the mobile device 10. Selecting one of the applications from the list in FIG. 8 results in a further interface screen that displays information about the selected application (including for example the modules that make up the selected application). Turning again to FIGS. 6A and 6B, other sample option items 72 from the Advanced Option sub-menu list can, for example, link to the associated user interface screens as follows: Browser Push 146—links to interface screen that allows user to enable/disable features controlling how information is pushed to the mobile electronic device 10; Cell Broadcast 148—links to interface screen that allows user to set channel and language preferences for cell broadcasts; Enterprise Activation 150—links to interface screen that facilitates enterprise activation; Host Routing Table 152—links to interface screen that provides host routing information; Message Services 154—links to interface screen that allows user to view and change messaging options; Subscriber Identity Module (SIM) Card 158—links to a screen that displays SIM ID and phone number; and Transport Control Protocol (TCP) 160.

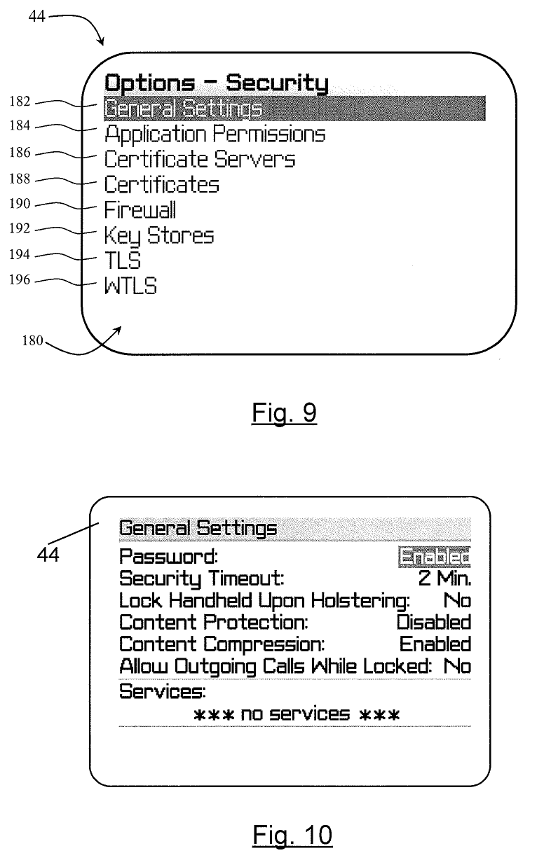

Referring again to the main options menu 100 of FIGS. 4A and 4B, a further main menu expandable menu item that links to a sub-group of option items is the “Security Options” item 120. In an example embodiment, when the “Security Options” item 120 is selected by user, a security options sub-menu 180, as shown in FIG. 9 is displayed on the screen 44. As shown in FIG. 9, the security options sub-menu 180 has a plurality of selectable security options items, including: General Settings 182, Application Permissions 184, Certificate Servers 186, Certificates 188, Firewall 190, Key Stores 192, Memory Cleaning 194, Smart Card 196, Secure/Multipurpose Internet Mail Extensions (S/MIME) (not shown), Transport Layer Security (TLS) (not shown), and Wireless Transport Layer Security (WTLS) (not shown). Selection of the items from sub-menu 180 causes generation of user interface screens that display information about the selected security item and, in some cases, allow the device user to change security settings for the item. By way of example, FIG. 10 shows a sample user interface screen generated in response to selection of the General Settings 182 menu item. The user interface of FIG. 10 enables a user to change at least some of the displayed security settings. Thus, some of the menu items in advanced options sub menu interface 70 link to user interfaces that just display information, and some of the menu items link to user interfaces that display information and also permit the user to change operational settings of the device 10.

Referring again to FIGS. 4A and 4B, the in an example embodiment, the remaining menu items in main options menu 100 each link directly to a user interface screen that displays information, and in some cases allows the user to change the settings, associated with the selected option item. By way of example: selection of “Auto on/off” item 106 displays a user interface screen that enables a user to set automatic turn on and turn off times for the mobile device 10; and selection of“Autotext” item 108 displays a user configurable list of text combinations that are automatically converted to other text combinations (“cant” to “can't, for example).

Thus, according to example embodiments, at least some of the selectable items in the main options menu 100 are expandable menu items that each link to an associated group of items to be displayed in a sub-menu. In the above described embodiment, the “Advanced Options” menu item 104 and the “Security Options” menu item 120 are examples of master or expandable menu items that are each associated with a respective group of sub-menu option items. Such a configuration reduces the number of items displayed in the main options menu, and allows for logical organization of menu items.

Referring again to FIG. 3, a user may select icon 64 to cause the options module (314 in FIG. 2) to generate the main options menu 100 as shown in FIGS. 4A and 4B. From the main options menu 100, the user may select an option item (102, 104, 106, etc.) from the plurality of option items. Thus, instead of a long list of options, the options menu 100 includes at least some expandable menu items that are associated with sub-menus of option items. The order and arrangement of the option lists and the groups associated with high level or expandable menu items may be different and are not limited to the example embodiments described above. In at least some example embodiments the order and arrangement of the option items in the main menu, and sub-menus and the items associated with expandable menu items may be configured by the manufacturer or by the user. In at least one example embodiment, the menus and submenus are organized based on an anticipated frequency of use, with items that are generally used more frequently being placed in and directly accessible through the main menu and items that generally have a lower frequency of use being placed in sub-menus that are reachable through expandable menu items from the main menu or other sub-menus. Sub-menus can include option items that link to further sub-menus.

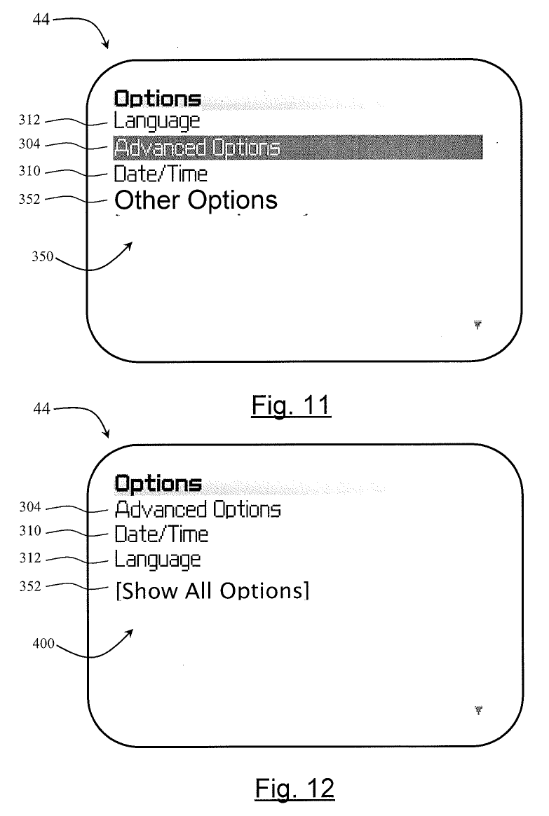

In some example embodiments, the option main menu and sub-menus can be adaptively configured by the options module 314 so that the option items are presented in a manner that corresponds to their actual frequency of use and/or when they were last used. For example, option items that are infrequently used and/or not recently used may be grouped into a sub-menu, or pushed further down in a displayed list of menu items. In this regard, FIG. 11 shows an example embodiment of an automatically adapting options interface, which replaces the main options menu interface 100 of FIGS. 4A and 4B and operates in the same manner as interface menu 100 except for differences that will be apparent from the present description. FIG. 11 shows user selectable option items in a main options menu 350 displayed on screen 44, in which certain option items have been selectively removed from the main options menu and grouped under an expandable menu item “Other Options” 352. In an example embodiment, the options module 314 is configured to display in the main options menu 350 the last three option items that were selected by the device user, and to display those three items in chronological order starting with the most recently used. The remaining option items can be reached through the item “Other Options”, selection of which brings up a sub-menu of the option items that are not included in the main options menu.

As shown in the example of FIG. 11, the main options menu 350 includes the following option fields: Language 312, Advanced Options 304, Date/Time 310, and Other Options 352. Thus, in such example, the last three option item selected by the user, from newest to oldest, are: Language 312, Advanced Options 304, and Date/Time 310. The remaining option items 66 from the interface 100 have been grouped into “Other Options” 352, and selection of the “Other Options” 352 item will result in generation of an interface sub-menu that includes the remaining option items. More or less than three menu items could be displayed on the main option menu interface 352, with three being an arbitrary number used for illustrative purposes only. The number of items displayed could vary, for example with the most recently accessed items for the last X number of days being displayed. It will be noted that in the illustrated example, the expandable option menu item “Security Options” is not shown in the main option interface 350, and has been pushed down into group associated with “Other Options”. Within the sub-menu associated with “Other Options”, the options items can also be displayed in a time-based order, starting with the option item most recently selected from among those appearing in the “Other Options” list.

Menu items that have been pushed down into the “Other Options” sub-menu will be pushed back up into the main options menu when they are again accessed by the user, with items previously appearing in the main menu options interface 350 then being pushed down into the “Other Options” sub-menu.

In some embodiments, the prioritized option items shown in the main options interface may be organized alphabetically rather than in any chronological order, and in this regard FIG. 12 shows an interface 400 that is the same as interface 350, except that the three most recently accessed menu options are in alphabetical order.

In at least some example embodiments, the menu items that are adaptively selected for display in the main options menu 350 could be based on predetermined criteria other than or in addition to most recent use, including for example frequency of use. Thus, for example, the device 10 can be configured to track each time that a menu item has been selected, and display a selected number (for example five) of the menu items most frequently accessed since activation of the device (or other predetermined time period) in the main option interface 350, and push the remaining menu items down into a sub-menu accessible through an expandable menu item (eg. Other items menu item 352. The menu items displayed on the main menu interface 350 or in the sub-menu will change over time as frequency of selection the menu items by a user varies. In some embodiments, the menu items within each menu interface can be ordered from top to bottom based on descending frequency of use.

In the examples described above, once a master option item is selected, the existing menu shown on the display screen 44 is replaced in its entirety with the appropriate sub-menu. Pressing a predetermined “back” key on the device 10 will return the user to the previously displayed menu.

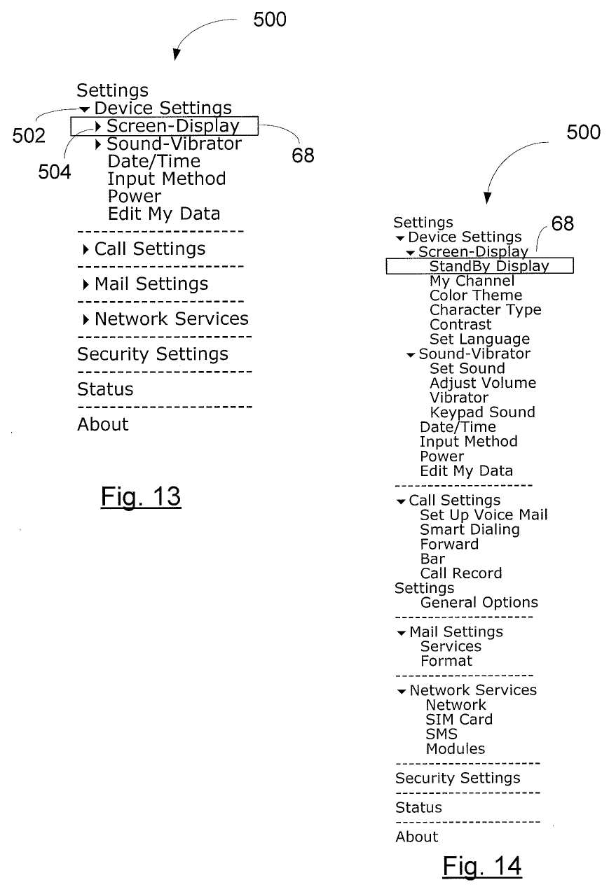

FIGS. 13 and 14 illustrate user interface screens that can be generated by options module 314 in accordance with yet a further example embodiment. In particular, FIG. 13 illustrates an example of a default main options menu interface 500 generated in response to user selection of options icon 64. FIG. 14 illustrates an expanded view of the same options menu interface 500. Referring to FIG. 13, position marker or selection indicator 68 can be scrolled through the list of selectable option menu items to highlight and select menu items. In some embodiments, the entire list shown in FIGS. 13 and 14 is not simultaneously displayed on the screen 44 of mobile device 10, but rather only parts of the list are shown as the user scrolls through.

At least some of the menu items are “expandable” items that are associated with further groups of sub-menu items. In the illustrated device options menu 500, the items “Device Settings”; “Screen-Display”; “Sound-Vibrator”; “Call Settings”; “Mail Settings”; and “Network Services” are each expandable items, and a visual indicator that such items are each associated with a further group of sub-menu items is provided by the down arrow head indicia 502 and the right arrow head indicia 504. The down arrow head indicia 502 is used to indicated a menu item that is being displayed in an expanded state, and the right arrow head indicia 504 indicates a menu item that has not been expanded. Thus, in the default menu view of FIG. 13, the menu item “Device Settings” is displayed in an expanded view (showing the sub-menu items associated with it, namely “Screen-Display”; “Sound-Vibrator”; “Date/Time”; “Input Method”; “Power” and “Edit My Data”), and the menu items “Screen-Display”; “Sound-Vibrator”; “Call Settings”; “Mail Settings”; and “Network Services” are each displayed in a contracted state. In FIG. 14, the menu items “Screen-Display”; “Sound-Vibrator”; “Call Settings”; “Mail Settings”; and “Network Services” are all shown in an expanded state with their respective groups of associated sub-menu items displayed.

User selection of an expandable menu item that is marked with a right-arrow indicia 504 causes the selected menu item to be expanded, such that the group of sub-menu items associated with the selected expandable menu item are displayed under the menu item. By way of example, selecting “Mail Settings” from the menu as displayed in FIG. 13 will result in the “Mail Settings” sub-menu items “Services” and “Format” being displayed as shown in FIG. 14. User selection of an expanded menu item that is marked with a down arrow indicia 502 causes the selected menu item to be contracted—by way of example, selecting the expanded “Mail Settings” from the menu as displayed in FIG. 14 will result in the “Mail Settings” sub-menu items “Services” and “Format” being removed from the displayed menu as shown in FIG. 13. Such a configuration reduces the length of the default menu that the user must scroll through, with the user selectively expanding and contacting menu items as desired. The embodiments of FIGS. 13 and 14 differ from the previously described embodiments in that the menu items of the main options menu interface are not overwritten on the display screen 44 when the sub-menu items are displayed—rather, as will be appreciated from the different views presented in FIGS. 13 and 14, the entire menu expands or contracts so that the user can scroll selection marker 68 through all including items from the main options menu items, and any displayed sub-menu items.

In example embodiments, the menu item features described above can be applied to menu lists displayed on mobile devices other than just “options” menus.

While the invention has been described in detail in the foregoing specification, it will be understood by those skilled in the art that variations may be made without departing from the scope of the invention, being limited only by the appended claims.

What is claimed is:

1. A hand-held electronic mobile device comprising:
a controller including at least one processor, for controlling operation of the mobile device;
a display coupled to the controller;
a user input device coupled to the controller for receiving user input selections;
a storage coupled to the controller; and
a rigid case dimensioned to be held in a hand of a user, the case housing the controller, the display, the user input device and the storage;
the controller being operative to (i) generate on the display a user interface screen having a plurality of user selectable icons, one of the icons being an options icon; (ii) generate on the display, in response to user selection of the options icon, a main options menu listing a plurality of user selectable option items, at least one of the option items being an expandable menu item associated with a group of user selectable sub-menu option items; (iii) generate on the display, in response to user selection of the at least one expandable menu item, a sub-menu listing the sub-menu option items; (iv) generate on the display, in response to user selection of at least one of the sub-menu option items, a user interface screen for a user to change an operational setting of the mobile device.

2. The device of claim 1 wherein the controller is configured to provide a graphical indicia next to displayed expandable menu items to visually identify the expandable menu items.

3. The device of claim 1 wherein an expandable menu item for device security is included in the main options menu, the expandable device security menu item being associated with option items for setting security features of the mobile device.

4. The device of claim 1 wherein the controller is operative to automatically change the option items included in the main options menu in dependence on user selection history of the option items.

5. The device of claim 4 wherein the controller is operative to include in the main options menu a predetermined number of most recently selected option items.

6. The device of claim 5 wherein the controller is operative to include in the sub-menu the option items that are not included in the most recently selected option items.

7. The device of claim 1 wherein the controller is operative to track a selection history for the option items included in the menus and to automatically allocate items between the main options menu and the sub-menu based on relative selection frequencies of the option items.

8. The device of claim 1 wherein the user input device includes a rotatable and depressible mechanism that can be rotated to highlight a displayed option item and depressed to select a highlighted option item.

9. A method of generating options menus on a hand-held electronic mobile device that includes a hand-held case with a display and a user input device, the method including:
generating on the display a user interface screen having a plurality of user selectable icons, one of the icons being an options icon associated with user configurable options for the mobile device;
generating on the display, in response to user selection of the options icon, a main options menu listing a plurality of user selectable option items, at least one of the option items being an expandable menu item associated with a group of sub-menu option items;
generating on the display, in response to user selection of the at least one expandable menu item, a sub-menu listing the sub-menu option items; and
generating on the display, in response to user selection of at least one of the sub-menu option items, a user interface screen for a user to change an operational setting of the mobile device.

10. The method of claim 9 including providing a graphical indicia next to displayed expandable menu items to visually identify the expandable menu items.

11. The method of claim 9 including automatically changing the option items included in the main options menu in dependence on user selection history of the option items.

12. The method of claim 11 including tracking which of the option items have been most recently selected by a user of the device, and wherein the main options menu includes a predetermined number of the most recently selected option items.

13. The method of claim 11 including tracking which of the option items have been most frequently selected by a user of the device, and wherein the main options menu includes a predetermined number of the most frequently selected option items.

14. The method of claim 9 including, when generating the sub-menu on the display, overwriting the main options menu so that only the sub-menu is shown on the display.

15. A computer program product comprising a computer readable medium carrying instructions for enabling a processor to execute the method of claim 9.

16. A hand-held electronic mobile device comprising:
a controller including at least one processor, for controlling operation of the mobile device;
a display coupled to the controller;
a user input device coupled to the controller for receiving user input selections;
a storage coupled to the controller; and
a rigid case dimensioned to be held in a hand of a user, the case housing the controller, the display, the user input device and the storage;
the controller being operative to (i) generate on the display a user interface screen having a plurality of user selectable icons including at least one icon for linking to a list of menu items; (ii) generate on the display, in response to user selection of the at least one icon, a main menu listing a plurality of user selectable menu option items, at least one of the menu option items being an expandable menu item associated with a group of user selectable sub-menu option items; and (iii) generate on the display, in response to user selection of the at least one expandable menu item, a sub-menu listing the sub-menu option items;
the controller adaptively allocating the option items between the main menu and the sub-menu in dependence on a user selection history for the option items.

17. The device of claim 16 wherein the controller is operative to track which of the option items have been most frequently selected by a user of the device, and include in the main menu a predetermined number of the most frequently selected option items.

18. The device of claim 16 wherein the controller is operative to track which of the option items have been most recently selected by a user of the device, and wherein the main options menu includes a predetermined number of the most recently selected option items.

19. A method of generating options menus on a hand-held electronic mobile device, comprising:
providing a hand-held case with a display and a user input device, the device being configured for generating on the display a main menu listing a plurality of user selectable menu items and an expandable menu item associated with a group of sub-menu items; generating on the display, in response to user selection of the expandable menu item, a sub-menu listing a plurality of menu items; and
adaptively allocating the menu items between the main menu and the sub-menu in dependence on a user selection history for the menu items.

20. The method of claim 19 wherein adaptively allocating the option items includes tracking which of the menu items have been most frequently selected by a user of the device, and including in the main menu a predetermined number of the most frequently selected menu items.
